(19) United States
(12) Patent Application Publication
(10) Pub. No.: US 2026/0179362 A1
(43) Pub. Date: Jun. 25, 2026

(54) SYSTEM AND METHOD FOR TRAINING ROBUST MEDICAL IMAGING FOUNDATION MODELS

(71) Applicant: GE Precision Healthcare LLC, Waukesha, WI (US)

(72) Inventors: Pengwei Wu, Clifton Park, NY (US); Bruno Kristiaan Bernard De Man, Clifton Park, NY (US)

(21) Appl. No.: 18/999,648

(22) Filed: Dec. 23, 2024

(51) Int. Cl. G06V 10/774; G06V 10/74; G06V 10/77; G06V 10/82

(52) U.S. Cl. CPC G06V 10/774; G06V 10/761; G06V 10/7715; G06V 10/82; G06V 2201/03

(57) ABSTRACT

A method includes randomly selecting both a subset of subjects from a plurality of subjects and one or more medical images from different protocols for each respective subject of the subset of subjects. The method includes obtaining an encoder-decoder framework. The method includes pretraining an encoder of the encoder-decoder framework with the one or more medical images from different protocols for each respective subject of the subset of subjects utilizing self-supervised learning with a physics informed contrastive loss function to generate a trained protocol invariant encoder configured to be utilized for different downstream tasks, wherein utilizing the physics informed contrastive loss function promotes similar latent space features to be extracted from of the one or more medical images of a same subject while repelling latent space features from different subjects, and wherein the similar latent space features represent a same underlying anatomical structure.

### STATEMENT REGARDING FEDERALLY SPONSORED RESEARCH & DEVELOPMENT

This invention was made with US Government support under contract number R01HL32250 awarded by the National Heart, Lung, & Blood Institute of the US Department of Health and Human Services National Institutes of Health. The Government has certain rights in the invention.

### BACKGROUND

The subject matter disclosed herein relates to imaging systems and, more particularly, to system and method for training robust medical imaging foundation models.

Non-invasive imaging technologies allow images of the internal structures or features of a patient to be obtained without performing an invasive procedure on the patient. In particular, such non-invasive imaging technologies rely on various physical principles, such as the differential transmission of X-rays through the target volume or the reflection of acoustic waves, to acquire data and to construct images or otherwise represent the observed internal features of the patient.

For example, in computed tomography (CT) and other X-ray based imaging technologies, X-ray radiation spans a subject of interest, such as a human patient, and a portion of the radiation impacts a detector where the image data is collected. In digital X-ray systems a photodetector produces signals representative of the amount or intensity of radiation impacting discrete pixel regions of a detector surface. The signals may then be processed to generate an image that may be displayed for review. In CT imaging systems, a detector array, including a series of detector elements, produces similar signals through various positions as a gantry is displaced around a patient.

Deep learning has been widely used in medical imaging (CT included) for applications like denoising, artifacts correction, motion compensation, material decomposition, segmentation, and so on. However, the variability in CT acquisition protocols, such as differences in tube current (e.g., in milliamperes (mA)), tube voltage (e.g., in kilovolts (kV)), reconstruction kernels, the presence of artifacts, different CT scanner models (from the same vendor or from different vendors), poses significant challenges for various deep learning models (e.g., segmentation, denoising, image enhancement, image analysis). These models often exhibit considerable performance degradation (i.e., domain shift) when trained on images acquired using one protocol and tested on images obtained with unseen imaging protocols and/or from different scanner models. This can lead to reduced model performance and image quality. This variability can lead to a decline in diagnostic accuracy and generalizability, which limits the practical utility of deep learning in clinical settings.

Self-supervised learning (SSL) has emerged as a promising approach in computer vision to address some of these challenges by leveraging large amounts of unlabeled data to learn robust and invariant feature representations. In medical imaging, self-supervised learning techniques have shown potential in enhancing feature extraction. However, most of these approaches were proposed for natural images and do not fully capture the complexities and variations inherent in medical imaging protocols.

### SUMMARY

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In one embodiment, a computer-implemented method for generating a medical imaging foundation model and a medical imaging derivative model is provided. The computer-implemented method includes randomly selecting, via processing system including one or more processors, both a subset of subjects from a plurality of subjects and one or more medical images from different protocols for each respective subject of the subset of subjects. The computer-implemented method also includes obtaining, via the processing system, an encoder-decoder framework. The computer-implemented method further includes pretraining, via the processing system, an encoder of the encoder-decoder framework with the one or more medical images from different protocols for each respective subject of the subset of subjects utilizing self-supervised learning with a physics informed contrastive loss function to generate a trained protocol invariant encoder configured to be utilized for different downstream tasks, wherein utilizing the physics informed contrastive loss function promotes similar latent space features to be extracted from of the one or more medical images of a same subject from different protocols while repelling latent space features from different subjects, and wherein the similar latent space features represent a same underlying anatomical structure.

In another embodiment, a system for generating a medical imaging foundation model and a medical imaging derivative model is provided. The system includes a memory encoding processor-executable routines. The system also includes a processing system including one or more processors and configured to access the memory and to execute the processor-executable routines. The processor-executable routines, when executed by the processing system, cause the processing system to randomly select both a subset of subjects from a plurality of subjects and one or more medical images from different protocols for each respective subject of the subset of subjects. The processor-executable routines, when executed by the processing system, also cause the processing system to obtain an encoder-decoder framework. The processor-executable routines, when executed by the processing system, further cause the processing system to pretrain an encoder of the encoder-decoder framework with the one or more medical images from different protocols for each respective subject of the subset of subjects utilizing self-supervised learning with a physics informed contrastive loss function to generate a trained protocol invariant encoder configured to be utilized for different downstream tasks, wherein utilizing the physics informed contrastive loss function promotes similar latent space features to be extracted from the one or more medical images of a same subject for different protocols while repelling latent space features from different subjects, and wherein the similar latent space features represent a same underlying anatomical structure.

In a further embodiment, a non-transitory computer-readable medium is provided. The non-transitory computer-readable medium includes processor-executable code that when executed by a processing system including one or more processors, causes the processing system to perform actions. The actions include randomly selecting both a subset of subjects from a plurality of subjects and one or more medical images from different protocols for each respective subject of the subset of subjects. The actions also include obtaining an encoder-decoder framework. The actions further include pretraining an encoder of the encoder-decoder framework with the one or more medical images from different protocols for each respective subject of the subset of subjects utilizing self-supervised learning with a physics informed contrastive loss function to generate a trained protocol invariant encoder configured to be utilized for different downstream tasks, wherein utilizing the physics informed contrastive loss function promotes similar latent space features to be extracted from of the one or more medical images of a same subject from different protocols while repelling latent space features from different subjects, and wherein the similar latent space features represent a same underlying anatomical structure. The actions even further include using the trained protocol invariant encoder to generate the medical imaging derivative model.

### BRIEF DESCRIPTION OF THE DRAWINGS

These and other features, aspects, and advantages of the disclosed subject matter will become better understood when the following detailed description is read with reference to the accompanying drawings in which like characters represent like parts throughout the drawings, wherein:

FIG. 1 is a combined pictorial view and block diagram of a computed tomography (CT) imaging system, in accordance with aspects of the present disclosure;

FIG. 2 is a schematic diagram of a process for pretraining an encoder-decoder framework to be a protocol-invariant framework, in accordance with aspects of the present disclosure;

FIG. 3 is a schematic diagram of a process for fine tuning or training of a decoder of a protocol-invariant framework, in accordance with aspects of the present disclosure;

FIG. 4 is a flow diagram of a method for generating a medical imaging foundation model, in accordance with aspects of the present disclosure;

FIG. 5 is a flow diagram of a method for generating a trained deep learning network or model for a downstream task, in accordance with aspects of the present disclosure;

FIG. 6 is a schematic diagram of a process for generating realistic multi-protocol images for contrastive setup, in accordance with aspects of the present disclosure;

FIG. 7 is a flow diagram of a method for generating realistic multi-protocol images for contrastive setup, in accordance with aspects of the present disclosure;

FIG. 8 depicts images illustrating segmentation performance on various imaging protocols, in accordance with aspects of the present disclosure;

FIG. 9 depicts Dice coefficients stratified by protocol for the segmentation performance on various imaging protocols, in accordance with aspects of the present disclosure; and

FIG. 10 depicts Dice coefficients stratified by organ for the segmentation performance on various imaging protocols, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present subject matter, the articles “a,” “an,” “the,” and “said” are intended to mean that there are one or more of the elements. The terms “comprising,” “including,” and “having” are intended to be inclusive and mean that there may be additional elements other than the listed elements. Furthermore, any numerical examples in the following discussion are intended to be non-limiting, and thus additional numerical values, ranges, and percentages are within the scope of the disclosed embodiments.

While aspects of the following discussion are provided in the context of medical imaging, it should be appreciated that the disclosed techniques are not limited to such medical contexts. Indeed, the provision of examples and explanations in such a medical context is only to facilitate explanation by providing instances of real-world implementations and applications. However, the disclosed techniques may also be utilized in other contexts, such as image reconstruction for non-destructive inspection of manufactured parts or goods (i.e., quality control or quality review applications), and/or the non-invasive inspection of packages, boxes, luggage, and so forth (i.e., security or screening applications). In general, the disclosed techniques may be useful in any imaging or screening context or image processing or photography field where a set or type of acquired data undergoes a reconstruction process to generate an image or volume.

Deep-learning (DL) approaches discussed herein may be based on artificial neural networks, and may therefore encompass one or more of deep neural networks, fully connected networks, convolutional neural networks (CNNs), vision transformers, unrolled neural networks, perceptrons, encoders-decoders, recurrent networks, wavelet filter banks, u-nets, general adversarial networks (GANs), dense neural networks, or other neural network architectures. The neural networks may include shortcuts, activations, batch-normalization layers, and/or other features. These techniques are referred to herein as DL techniques, though this terminology may also be used specifically in reference to the use of deep neural networks, which is a neural network having a plurality of layers.

One type of deep learning model is a vision transformer model. A vision transformer model utilizes transformers (e.g., vision transformers) for image recognition tasks. In particular, a vision transformer model breaks down an input image (e.g., medical image) into patches, processes these patches using transformers, and aggregates the information for classification or regression. A vision transformer model utilizes self-attention (i.e., a global operation) since it draws information from the whole image. This enables the vision transformer model to capture distinct semantic relevancies in an image effectively. Vision transformer models could potentially obtain similar or better results than other types of deep learning models (e.g., convolutional networks).

As discussed herein, DL techniques (which may also be known as deep machine learning, hierarchical learning, or deep structured learning) are a branch of machine learning techniques that employ mathematical representations of data and artificial neural networks for learning and processing such representations. By way of example, DL approaches may be characterized by their use of one or more algorithms to extract or model high level abstractions of a type of data-of-interest. This may be accomplished using one or more processing layers, with each layer typically corresponding to a different level of abstraction and, therefore potentially employing or utilizing different aspects of the initial data or outputs of a preceding layer (i.e., a hierarchy or cascade of layers) as the target of the processes or algorithms of a given layer. In an image processing or reconstruction context, this may be characterized as different layers corresponding to the different feature levels or resolution in the data. In general, the processing from one representation space to the next-level representation space can be considered as one ‘stage’ of the process. Each stage of the process can be performed by separate neural networks or by different parts of one larger neural network.

In the present disclosure, the term “protocol” is a generic term that broadly refers to factors that result in variability in medical images (e.g., CT images). For example, these factors may be changes in CT scan protocol such as tube current, tube voltage, rotation speed. Or these factors may be changes in the reconstruction and image presentation, such as reconstruction kernel, display field of view. Or these factors could be differences in the actual imaging system, such as the system vendor, system model, or system geometry. Or they could be differences in image quality, such as various forms of artifacts, noise, resolution level, and other factors.

Although the following disclosure discusses the disclosed techniques in the context of computed tomography, the disclosed techniques may be utilized with medical imaging data acquired with other imaging modalities (e.g., magnetic resonance imaging (MRI), positron emission tomography (PET), etc.). Multiple image datasets of the same patient/anatomy can refer to multiple images of the same imaging modality (e.g., acquired with different scan techniques, different MRI sequences, different scanner models, different reconstruction parameters, different spectrums, etc.). In certain embodiments, multiple image datasets of the same patient/anatomy can refer to multiple images from different imaging modalities (e.g., CT and MR, PET and MR, PET and CT, PET and CT and MR, etc.). The images can be obtained through actual repeat scans or through simulations.

Unlike the conventional train-from-scratch approach, self-supervised learning can create generalist feature encoders that can be used for many specific downstream tasks (e.g., segmentation and denoising) without large-scaled labeled datasets. Also, training a foundation model using self-supervised learning has emerged as a promising approach in computer vision to address some these challenges by leveraging large amounts of unlabeled data to learn robust and invariant feature representations. These feature representations can then be used to train simple decoders for downstream tasks (e.g., denoising or segmentation), thus the name foundation model (i.e., a foundation for downstream models).

As noted above, self-supervised learning techniques usually utilize natural images that do not fully capture the complexities and variations inherent in medical imaging protocols. However, one key observation unique to medical images is that images of the same patient acquired with different CT protocols share the same underlying anatomy. Building on this observation, the present disclosure provides systems and methods for training a robust medical imaging foundation model (e.g., CT foundation model). In particular, a latent space is generated that, despite differences in acquisition protocol, has similar values (or feature representations) when representing the same underlying anatomical structures. In particular, the disclosed systems and methods that utilize a label-free self-supervised learning framework for medical imaging (e.g. CT imaging) that significantly reduces domain shift by employing a physics-informed contrastive loss (PICL) function to train a protocol-invariant encoder (PIE) of a foundation model. Using PICL, a generalist PIE is trained that can be used for other downstream tasks by training a corresponding decoder of the foundation model. By ensuring that different images of the same patient (e.g., subject) produce similar feature representations, the disclosed techniques significantly reduce domain shift of the resulted deep learning models across protocol variations.

In certain embodiments, the disclosed systems and methods include utilizing contrastive learning for medical imaging (e.g., CT imaging) that leverages physics-based models to simulate different CT scans of the same patient under varying acquisition protocols. Using contrastive learning, the foundation model is trained to generate similar features for these varied scans aiming to create a robust and protocol-invariant feature representations. By ensuring the different scans of the same patient produce consistent feature representations, the disclosed techniques significantly reduce the discrepancies that typically arise when a model trained on one protocol is applied to another. The foundation model generated with the disclosed techniques serves as a base model for developing robust and protocol-invariant downstream deep learning models (e.g., for denoising and segmentation). The disclosed techniques reduce the amount of training data need while increasing the robustness of the resulting downstream deep learning models. The disclosed techniques explicitly utilize different protocol information in medical imaging foundation model (as opposed to simply treating each image as an individual case without providing prior knowledge that they are from the same patient).

The disclosed systems and methods (e.g., for generating a medical imaging foundation model) include randomly selecting both a subset of subjects from a plurality of subjects and one or more medical images from different protocols for each respective subject of the subset of subjects. The disclosed systems and methods also include obtaining an encoder-decoder framework. The disclosed systems and methods also include pretraining an encoder of the encoder-decoder framework with the one or more medical images from different protocols for each respective subject of the subset of subjects utilizing self-supervised learning with a physics informed contrastive loss function to generate a trained protocol invariant encoder configured to be utilized for different downstream tasks, wherein utilizing the physics informed contrastive loss function promotes similar latent space features to be extracted from of the one or more medical images of a same subject from different protocols while repelling latent space features from different subjects, and wherein the similar latent space features represent a same underlying anatomical structure. The disclosed systems and methods also include freezing weights of the trained protocol invariant encoder to generate the medical imaging foundation model.

In certain embodiments, the disclosed systems and methods also include training a decoder of the encoder-decoder framework for a particular downstream task with medical images from a single protocol of different subjects while the weights of the trained protocol invariant encoder remain frozen. In certain embodiments, after training the decoder, the encoder-decoder framework is configured to be utilized on medical images from different protocols for the particular downstream task. In certain embodiments, after training the decoder, the medical imaging foundation model is configured to be resistant to domain shift. In other embodiments, rather than freezing the encoder, the pre-trained encoder-decoder (including the encoder) can be further trained specifically for a downstream task resulting in a derivative model, based on the transfer learning principle.

In certain embodiments, when pretraining the encoder-decoder framework with the one or more medical images from different protocols, the encoder of the encoder-decoder framework is pretrained to extract features via auto-encoding and inpainting with random masks. In certain embodiments, the encoder of encoder-decoder framework is pretrained with the one or more medical images from different protocols utilizing both the physics informed contrastive loss function and self-supervised L1 loss function from the auto-encoding and the inpainting. In certain embodiments, the encoder-decoder framework includes a vision transformer for the encoder. In certain embodiments, at least some medical images of the one or more medical images from different protocols for the plurality of subjects are simulated medical images generated from actual reference medical imaging data of at least some subjects of the plurality of subjects.

In certain embodiments, selection of medical images for the subset of subjects is from computed tomography (CT) images. In certain embodiments, the simulated medical images are generated by obtaining actual reference medical imaging data acquired with a CT scan of a respective subject, generating a multi-material voxelized phantom based on the actual reference imaging data, and then utilizing physics-based models to systematically vary acquisition parameters to generate CT imaging data of the respective subject from a series of CT scans representing different protocols from the actual reference medical imaging data. In certain embodiments, the simulated medical images are generated by obtaining actual reference medical imaging data acquired with a CT scan of a respective subject, and generating variations on that CT image by adding noise, adding artifacts, and performing spatial filtering to modify the frequency content of the CT image.

In certain embodiments, disclosed non-transitory computer-readable medium includes processor-executable code that when executed by a processing system including one or more processors, causes the processing system to perform actions. The actions include randomly selecting both a subset of subjects from a plurality of subjects and one or more medical images from different protocols for each respective subject of the subset of subjects. The actions also include obtaining an encoder-decoder framework. The actions further include pretraining an encoder of the encoder-decoder framework with the one or more medical images from different protocols for each respective subject of the subset of subjects utilizing self-supervised learning with a physics informed contrastive loss function to generate a trained protocol invariant encoder configured to be utilized for different downstream tasks, wherein utilizing the physics informed contrastive loss function promotes similar latent space features to be extracted from of the one or more medical images of a same subject from different protocols while repelling latent space features from different subjects, and wherein the similar latent space features represent a same underlying anatomical structure. The actions even further include freezing weights of the trained protocol invariant encoder to generate the medical imaging derivative model.

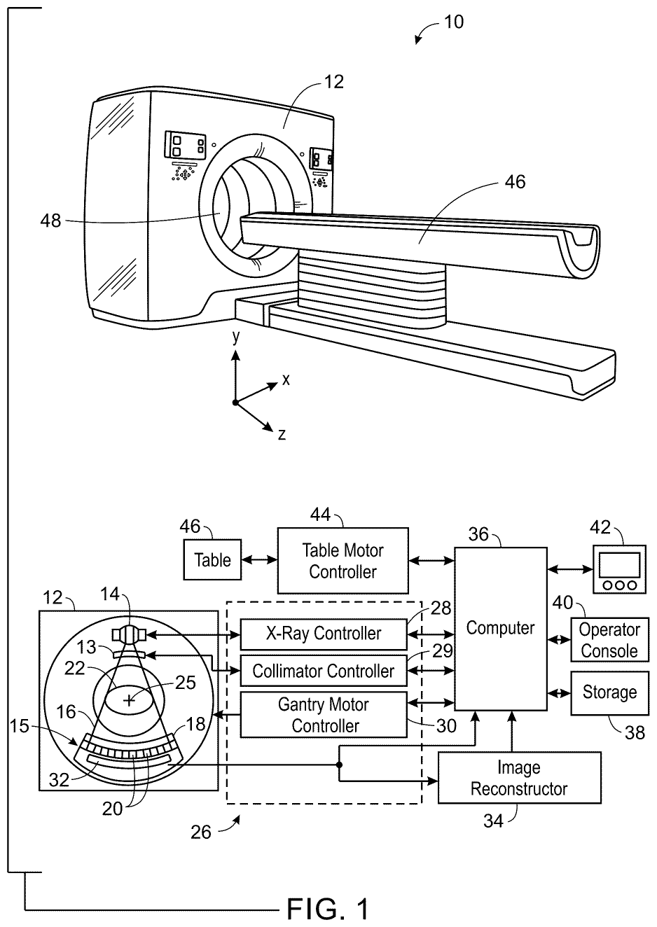

With the preceding in mind and referring to FIG. 1, a computed tomography (CT) imaging system 10 is shown, by way of example. The CT imaging system 10 includes a gantry 12. The gantry 12 has an X-ray source 14 that projects a beam of X-rays 16 toward a detector assembly 15 on the opposite side of the gantry 12. The X-ray source 14 projects the beam of X-rays 16 through a pre-patient collimator assembly 13 that determines the size and shape of the beam of X-rays 16. The detector assembly 15 includes a collimator assembly 18 (a post-patient collimator assembly), a plurality of detector modules 20 (e.g., detector elements or sensors), and data acquisition systems (DAS) 32. The plurality of detector modules 20 detect the projected X-rays that pass through a subject or object 22 being imaged, and DAS 32 converts the data into digital signals for subsequent processing. Each detector module 20 in a conventional system produces an analog electrical signal that represents the intensity of an incident X-ray beam and hence the attenuated beam as it passes through the subject or object 22. During a scan to acquire X-ray projection data, gantry 12 and the components mounted thereon rotate about a center of rotation 25 (e.g., isocenter) so as to collect attenuation data from a plurality of view angles relative to the imaged volume.

Rotation of gantry 12 and the operation of X-ray source 14 are governed by a control system 26 of CT imaging system 10. Control system 26 includes an X-ray controller 28 that provides power and timing signals to an X-ray source 14, a collimator controller 29 that controls a length and a width of an aperture of the pre-patient collimator 13 (and, thus, the size and shape of the beam of X-rays 16), and a gantry motor controller 30 that controls the rotational speed and position of gantry 12. An image reconstructor 34 receives sampled and digitized X-ray data from DAS 32 and performs high-speed image reconstruction. The reconstructed image is applied as an input to a computer 36, which stores the image in a storage device 38. Computer 36 also receives commands and scanning parameters from an operator via console 40. An associated display 42 allows the operator to observe the reconstructed image and other data from computer 36. The operator supplied commands and parameters are used by computer 36 to provide control signals and information to DAS 32, X-ray controller 28, collimator controller 29, and gantry motor controller 30. In addition, computer 36 operates a table motor controller 44, which controls a motorized table 46 (e.g., patient table) to position subject 22 and gantry 12. Particularly, table 46 moves portions of subject 22 through a gantry opening or bore 48.

A processing component (e.g., a microprocessor or processing circuitry) and a memory of the CT imaging system 10, such as may be present in computer 36 and/or control system 26, may be used to execute stored software code, instructions, or routines for acquiring and processing the CT data. The term “code” or “software code” used herein refers to any instructions or set of instructions that control the CT imaging system 10. The code or software code may exist in a computer-executable form, such as machine code, which is the set of instructions and data directly executed by the processing component, human-understandable form, such as source code, which may be compiled in order to be executed by the processing component, or an intermediate form, such as object code, which is produced by a compiler. In some embodiments, the CT imaging system 10 may include a plurality of controllers.

As an example, the memory may store processor-executable software code or instructions (e.g., firmware or software), which are tangibly stored on a non-transitory computer readable medium. Additionally or alternatively, the memory may store data. As an example, the memory may include a volatile memory, such as random-access memory (RAM), and/or a nonvolatile memory, such as read-only memory (ROM), flash memory, a hard drive, or any other suitable optical, magnetic, or solid-state storage medium, or a combination thereof. Furthermore, processing component may include multiple microprocessors, one or more “general-purpose” microprocessors, one or more special-purpose microprocessors, and/or one or more application specific integrated circuits (ASICS), or some combination thereof. For example, the processing component may include one or more reduced instruction set (RISC) or complex instruction set (CISC) processors. The processing component may include multiple processors, and/or the memory may include multiple memory devices.

In certain embodiments (e.g., for generating a medical imaging foundation model and a medical imaging derivative model), the processing component is configured to randomly select both a subset of subjects from a plurality of subjects and one or more medical images from different protocols for each respective subject of the subset of subjects. The processing component is also configured to obtain an encoder-decoder framework. The processing component is also configured to pretrain an encoder of the encoder-decoder framework with the one or more medical images from different protocols for each respective subject of the subset of subjects utilizing self-supervised learning with a physics informed contrastive loss function to generate a trained protocol invariant encoder configured to be utilized for different downstream tasks, wherein utilizing the physics informed contrastive loss function promotes similar latent space features to be extracted from of the one or more medical images of a same subject from different protocols while repelling latent space features from different subjects, and wherein the similar latent space features represent a same underlying anatomical structure. The processing component is even further configured to freeze weights of the trained protocol invariant encoder to generate the medical imaging foundation model.

In certain embodiments, the processing component is configured to train a decoder of the encoder-decoder framework for a particular downstream task with medical images from a single protocol of different subjects while the weights of the trained protocol invariant encoder remain frozen. In certain embodiments, by training the decoder, the encoder-decoder framework is configured to be utilized on medical images from different protocols for the particular downstream task. In certain embodiments, by training the decoder, the medical imaging foundation model is configured to be resistant to domain shift.

In certain embodiments, when pretraining the encoder-decoder framework with the one or more medical images from different protocols, the encoder of the encoder-decoder framework is pretrained to extract features via auto-encoding and inpainting with random masks. In certain embodiments, the encoder of encoder-decoder framework is pretrained with the one or more medical images from different protocols utilizing both the physics informed contrastive loss function and self-supervised L1 loss function from the auto-encoding and the inpainting. In certain embodiments, the encoder-decoder framework includes a vision transformer for the encoder. In certain embodiments, at least some medical images of the one or more medical images from different protocols for the plurality of subjects are simulated medical images generated from actual reference medical imaging data of at least some subjects of the plurality of subjects.

In certain embodiments, selection of medical images for the subset of subjects is from computed tomography (CT) images. In certain embodiments, the simulated medical images are generated by obtaining actual reference medical imaging data acquired with a CT scan of a respective subject, generating a multi-material voxelized phantom based on the actual reference imaging data, and then utilizing physics-based models to systematically vary acquisition parameters to generate CT imaging data of the respective subject from a series of CT scans representing different protocols from the actual reference medical imaging data.

In certain embodiments, the techniques disclosed herein may occur on a different type of imaging system (e.g., MRI system) or across multiple types of imaging systems having processing circuitry and memory circuitry. In certain embodiments, the techniques disclosed herein may occur on a separate computing device having processing circuitry and memory circuitry.

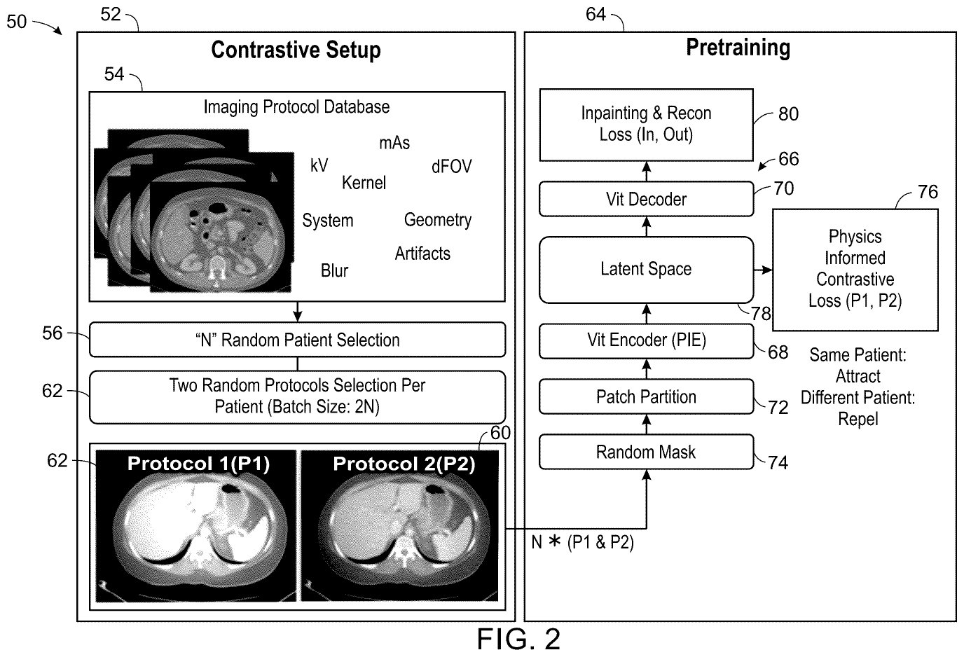

FIG. 2 is a schematic diagram of a process 50 for pretraining an encoder-decoder framework to be a protocol-invariant framework. As depicted on the left side of FIG. 2, the process 50 utilizes a contrastive setup step 52. During contrastive setup, an imaging protocol database 54 is accessed. The imaging protocol database 54 includes imaging data of a plurality of patients (e.g., subjects). Each patient includes imaging data from scans (e.g., CT scans) with different protocols. In certain embodiments, at least some of the imaging data of the plurality of patients is generated utilizing physics-based models to generate the diverse scans of the same patient. A subset of patients of the plurality of patients are randomly selected from the imaging protocol database 54 as indicated by reference numeral 56. In addition, images for each selected patient from two different protocols (e.g., Protocol 1 (P1) and Protocol 2 (P2) indicated by reference numerals 58 and 60, respectively) are randomly selected from the imaging protocol database 54 as indicated by reference numeral 62. Since the image pair P1 and P2 are from the same patient having the same underlying anatomy, their encoded features should have a high similarity.

As depicted on the right side of FIG. 2, the processes 50 utilizes a pretraining step 64. During the pretraining step, an encoder-decoder network 66 is pretrained. The encoder-decoder network 66 includes an encoder 68 and a decoder 70. As depicted, the encoder 68 is a vision transformer since it has superior performance compared to a CNN due to its ability to model longer range connection between pixels. In certain embodiments, a different network structure (e.g., CNN) may be utilized for the encoder 68. As depicted, the decoder 70 is a u-net transformer (UNETR). A UNETR includes a stack of vision transformers as the encoder and a CNN as the decoder that are linked together via skip connections. In certain embodiments, a different network structure (e.g., CNN) may be utilized for the decoder 70. The encoder-decoder network 66 (in particular, the encoder 68) is pretrained to perform proxy tasks. As depicted, the encoder-decoder network 66 is pretrained to extract features via auto-encoding (of patches from patch partitioning as indicated by reference numeral 72) and inpainting with random masks as indicated by reference numeral 74. In certain embodiments, the encoder-decoder network 66 may be pretrained to perform other proxy tasks (e.g., rotation prediction). The encoder-decoder network 66 is formulated as a multi-objective loss function.

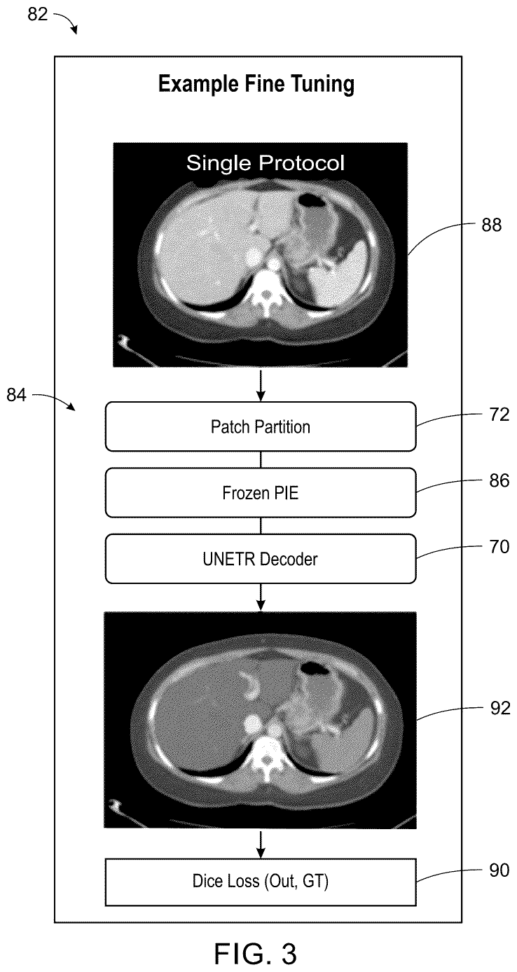

The image pair, P1 and P2, for each selected patient is inputted into the encoder-decoder network 66. Self-supervised learning with a physics informed contrastive loss (PICL) function 76 is utilized to train the encoder 68 to generate a trained protocol invariant encoder (PIE) configured to be utilized for different downstream tasks. The use of PICL promotes similar features (i.e., latent space features) in latent space 78 from P1 and P2 for each respective patient. The PICL function 76 is formulated to minimize the distance between the feature representations of different scans of the same patient. This is achieved by measuring cosine similarity in the feature space as indicated by the following equation:

$${L}_{i , j} = - log \frac{exp ( sim ( {z}_{i} , {z}_{j} ) / τ )}{{\sum }_{k = 1}^{2 N} {‖}_{\{ k \neq i \}} {exp ( s i m ( {z}_{i} , {z}_{k} ) / τ )}^{′}} \qquad ( 1 )$$

where L represents contrastive loss, sim represents cosine similarity, ∥_{{k≠i}} is an indicator function evaluating 1 if k≠i, τ denotes the temperature hyperparameters, j is the index of the matching image (same patient as i) whose feature space z should be attracted (higher similarity), k are all other images within the same batch (different patients) whose features should be repelled (lower similarity), N is the number of patients. Sample negative pairs are not sampled explicitly. Instead, other images from the same batch besides the positive pair are treated as negative pairs. The PICL function 76 attracts features from the same patient with different protocols but repels features from different patients. The final loss function is a weighted combination between PICL and self-supervised L1 losses (mean absolute error) (indicated by reference numeral 80). After the pretraining step 64, the trained protocol invariant encoder is frozen (i.e., the weights of the trained protocol invariant encoder are frozen) resulting in the generation of a medical imaging foundation model. This leaves only the decoder 70 to be trained for downstream tasks as described in FIG. 3. Since features from the encoder 68 are protocol-invariant due to the PICL function 76, the resultant network is resistant to (i.e., minimizes) domain shift even when trained for the downstream task with images from a single protocol. In other words, a model trained on a single protocol will generalize to other protocols, making it robust to domain shifts.

FIG. 3 is a schematic diagram of a process 82 for fine tuning or training of the decoder 70 of a protocol-invariant framework 84 (imaging foundation model having a trained protocol-invariant encoder 86). As depicted, the decoder 70 is an UNETR (e.g., including a stack of vision transformers as the encoder and a CNN as the decoder that are linked together via skip connections). In certain embodiments, a different network structure may be utilized for the decoder 70. In the fine-tuning stage, the protocol-invariant encoder 86 is changed with a downstream decoder that performs a downstream task. As depicted, the downstream task that the decoder 70 is trained for is segmentation (e.g., abdominal segmentation). In certain embodiments, the downstream task that the decoder 70 is trained for denoising, image enhancement, or another task.

Only a small amount of data is needed to fine tune the decoder 70. As depicted, medical images 88 of different patients from a single protocol are inputted into the protocol-invariant framework 84 for fine-tuning or training the decoder 70 chained to the trained protocol-invariant encoder 86 for the particular downstream task (e.g., abdominal segmentation). During the fine-tuning, the weights of the trained protocol-invariant encoder 86 remain frozen. As depicted for this example of image segmentation, Dice loss (as indicated by reference numeral 90) comparing output 92 of the protocol-invariant framework 84 to a ground truth is utilized during the training of the decoder 70. Dice loss would not be utilized if the decoder 70 is trained for a different downstream task (i.e., not segmentation). The fine-tuning of the decoder results in an efficiently trained robust downstream deep learning network configured to perform the downstream task. The resultant network is resistant to (i.e., minimizes) domain shift even when trained for the downstream task with the medical images 88 from the single protocol. In other words, a model trained on the single protocol will generalize to other protocols, making it robust to domain shifts.

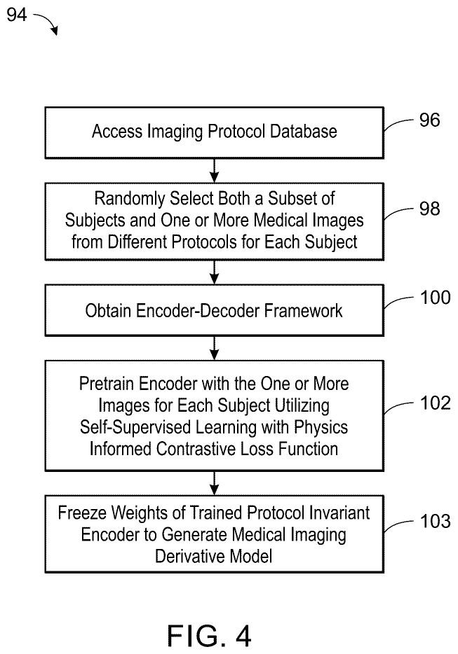

FIG. 4 is a flow diagram of a method 94 generating a medical imaging foundation model and a medical imaging derivative model for downstream tasks. One or more steps of the method 94 may be performed by processing circuitry of the computed tomography imaging system 10 in FIG. 1, another medical imaging system (e.g., MRI system), or a remote computing device.

The method 94 includes accessing an imaging protocol database that includes medical imaging data from different protocols for a plurality of subjects (e.g., patients) (block 96). For example, each subject includes imaging data from scans (e.g., CT scans) with different protocols in the imaging protocol database. In certain embodiments, at least some of the imaging data of the plurality of subjects is generated utilizing physics-based models to generate the diverse scans of the same subject (e.g., based on an actual reference scan of the subject). In embodiments (e.g., for some protocols such as reconstruction kernel), real multi-protocol certain images may be acquired for the same patient. In certain embodiments (e.g., where the imaging data is MR imaging data), the MRI data from different protocols is generated by acquiring different sequences (e.g., T1, T2, fluid-attenuated inversion recovery (FLAIR), etc.) of the same subject with the MRI system. The method 94 also includes randomly selecting both a subset of subjects from a plurality of subjects and one or more medical images from different protocols for each respective subject of the subset of subjects (block 98).

The method 94 further includes obtaining an encoder-decoder framework (block 100). In certain embodiments, when pretraining the encoder of the encoder-decoder framework with the one or more medical images from different protocols, the encoder of the encoder-decoder framework is pretrained to perform proxy tasks (e.g., extract features via auto-encoding and inpainting with random masks). In certain embodiments, an encoder of the encoder-decoder framework is a vision transformer. The method 94 further includes pretraining an encoder of the encoder-decoder framework with the one or more medical images from different protocols for each respective subject of the subset of subjects utilizing self-supervised learning with a physics informed contrastive loss function to generate a trained protocol invariant encoder configured to be utilized for different downstream tasks (block 102). Utilizing the physics informed contrastive loss function promotes similar latent space features to be extracted from of the one or more medical images of a same subject from different protocols while repelling latent space features from different subjects. The similar latent space features represent the same underlying anatomical structure. The encoder of the encoder-decoder framework is pretrained with the one or more medical images from different protocols utilizing both the physics informed contrastive loss function and another standard loss function (e.g., L1 loss function) from the auto-encoding and the inpainting (or other task the encoder was pretrained for). The method 94 further includes freezing weights of the trained protocol invariant encoder to generate the medical imaging derivative model (block 103). In certain embodiments, the weights of the trained protocol invariant encoder may not be frozen since the encoder may be retrained during training of the encoder-decoder for a downstream task.

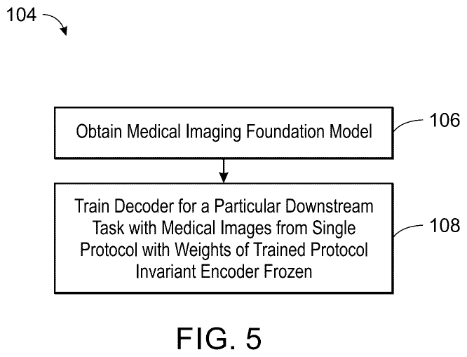

FIG. 5 is a flow diagram of a method 104 for generating a trained deep learning network or model for a downstream task. One or more steps of the method 104 may be performed by processing circuitry of the computed tomography imaging system 10 in FIG. 1, another medical imaging system (e.g., MRI system), or a remote computing device.

The method 104 includes obtaining a medical imaging foundation model (e.g., as generated in the method 94 in FIG. 3) having a frozen protocol-invariant encoder (block 106). The method 104 includes training a decoder of the medical imaging foundation model (i.e., decoder of the encoder-decoder framework of the method 94 in FIG. 3) for a particular downstream task with medical images from a single protocol of different subjects while the weights of the trained protocol invariant encoder remain frozen (block 108). The training of the decoder of the medical imaging foundation model results in a trained robust deep learning network or model configured to perform the downstream task. After training the decoder, the encoder-decoder framework (i.e., trained robust deep learning network or model) is configured to be utilized on medical images from different protocols for the particular downstream task since the encoder-decoder framework is resistant to domain shift.

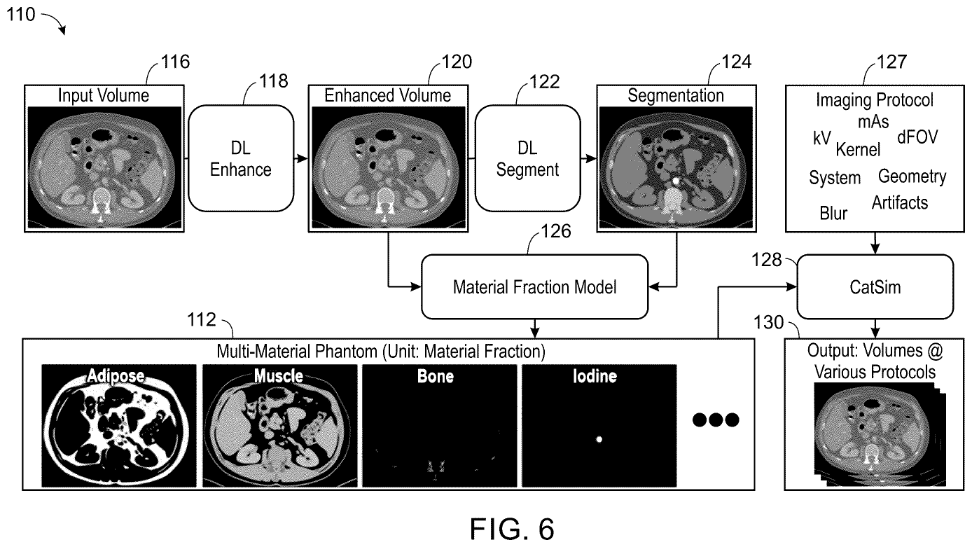

As noted above, in certain embodiments, at least some medical images of the one or more medical images from different protocols for the plurality of subjects are simulated medical images generated from actual reference medical imaging data of at least some subjects of the plurality of subjects. FIG. 6 is a schematic diagram of a process 110 for generating realistic multi-protocol images for contrastive setup. As depicted, the process 110 is for generating CT imaging data from different protocols for each subject or patient from an actual reference CT scan of the subject or patient.

The process 110 depicts a multi-material voxelized phantom generation pipeline 112 for generating a multi-material voxelized phantom 114 for a patient or subject. An actual reference input volume (or actual reference CT scan) 116 is inputted into a deep learning-based enhancement module 118. The deep learning-based enhancement module 118 is configured to greatly reduce image noise and enhance spatial resolution to generate an enhanced volume 120 (e.g., deep learning-enhanced volume) from the reference input volume 116. In certain embodiments, the deep learning-based enhancement module 118 is based on image restoration using a Swin transformer.

The enhanced volume 120 is inputted into a deep learning-based segmentation model 122 (e.g., open-source CT segmentation tool such as TotalSegmentator). The deep learning-based segmentation model 122 is configured to segment the enhanced volume into different tissue types (e.g., adipose, muscle, bone, and iodine). Image 124 is an example of an outputted image with segmentation from the deep-learning-based segmentation model 122. Both the enhanced volume 120 and the outputs from the deep learning-based segmentation model 122 are inputted into a material fraction model 126. The material fraction model is configured to generate the multi-material voxelized phantom 114 from the enhanced volume 120 and the outputs from the deep learning-based segmentation model 122. In the multi-material voxelized phantom 114, each voxel contains the material fraction for no more than two materials. The multi-material voxelized phantom 114 is noise-free and has no intrinsic blur. This enables proper noise and system blur to be introduced during CT simulation. The multi-material voxelized phantom 114 and the different imaging protocols (e.g., for CT) (as indicated by reference numeral 127) are inputted into a CT simulator 128 (e.g., called CatSim) that utilizes accurate physics-based models of different CT protocols for generating simulated CT volumes 130 (e.g., images) from different protocols for the same patient. The CT simulator 128 is configured to systematically vary acquisition parameters to generate the series of scans representing different protocols of the same patient.

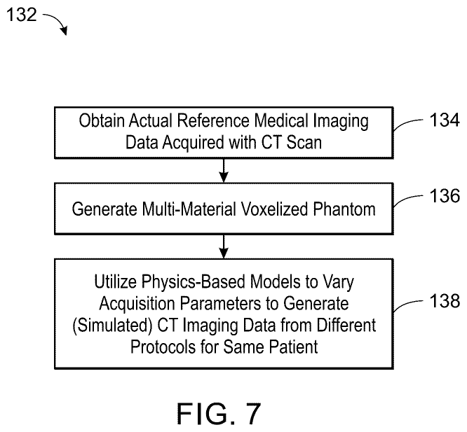

FIG. 7 is a flow diagram of a method 132 for generating realistic multi-protocol images for contrastive setup. One or more steps of the method 132 may be performed by processing circuitry of the computed tomography imaging system 10 in FIG. 1 or a remote computing device.

The method 132 includes obtaining actual reference medical imaging data acquired with a CT scan of a respective subject (block 134). The method 132 also includes generating a multi-material voxelized phantom based on the actual reference imaging data (block 136). In certain embodiments, prior to generating the multi-material voxelized phantom, the actual reference medical imaging data has its image noise reduced and spatial resolution enhanced (e.g., via a deep learning-based enhancement module), and then subjected segmentation into different tissue types (via a deep learning-based segmentation module). The method 132 further includes utilizing physics-based models to systematically vary acquisition parameters to generate CT imaging data (simulated CT imaging data) of the respective subject from a series of CT scans representing different protocols from the actual reference medical imaging data (block 138).

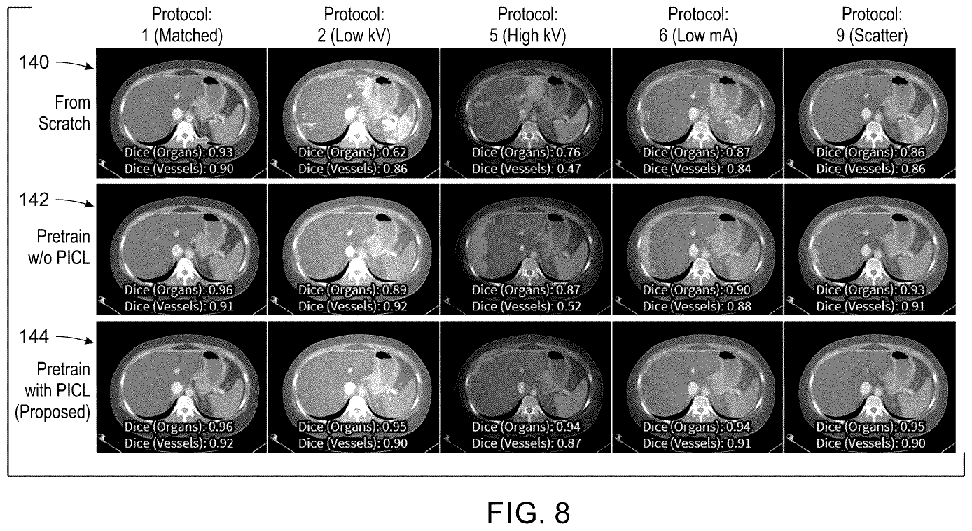

FIG. 8 depicts images illustrating segmentation performance on various imaging protocols. Deep learning segmentation was performed utilizing models that were each trained on images from a single protocol (protocol 1) for abdominal segmentation. A first model was derived from scratch with supervised training without pretraining. In this first model (from scratch model), only labeled training data for the specific segmentation task was used. A second model was derived from fine-tuning with the encoder pretrained without PICL loss. In the second model (pretrain w/o PICL), the encoder was pretrained with multi-protocol data. In a third model (pretrain with PICL), the encoder was pretrained with multi-protocol data utilizing PICL loss as described in the present disclosure above. All of the models used the same labeled data for the segmentation tasks.

The third model was pretrained using 600 patients. Among these patients, 500 patients were used in their original protocol (i.e., unchanged.). The other patients were made into voxelized phantoms, as described above, to generate 500 CatSim-simulated patients with different protocols. Protocols were randomly chosen. The data was divided into training, validation, and testing sets. No segmentation labels were provided for this data. After pretraining, the protocol-invariant encoder was frozen when training the decoder for downstream tasks.

Fine-tuning (for all three models) was performed utilizing data from 20 subjects with abdominal segmentation labels. These were divided into training, validation, and testing sets. The number of patients in the training of the decoder was kept small intentionally (i.e., 12 patients) to test the performance of the third model without large-scale labeled dataset. All 20 patients were converted into voxelized phantoms and used to generate simulated images at 10 different protocols.

A top row 140 of images represent segmentation on images from different protocols (protocols 1, 2, 5, 6, and 9) utilizing the first model (trained from scratch). The different protocols relate to tube voltage levels, tube current levels, and scatter levels. A middle row 142 of images represent segmentation on images from the same different protocols (1, 2, 5, 6, and 9) utilizing the second model (pretrained w/o PICL). A bottom row 144 of images represent segmentation on images from the same different protocols (protocols 1, 2, 5, 6, and 9) utilizing the third model (pretrained with PICL). Dice (organs) coefficients were measured for liver and spleen. Dice (vessels) coefficients were measured for aorta and inferior vena cava.

When tested on protocol 1, all three models worked well with a small advantage for the pretraining approaches as expected (approximately 0.05 improvement in Dice coefficient). However, when tested on other protocols, significant domain shift occurs in columns 2 through 5 of FIG. 8 with respect to the first model (trained from scratch) and the second model (pretrained without PICL). Various inspection of the segmentation results showed that the third model (pretrained with PICL) produced the most accurate and consistent segmentations across different protocol variations. The segmentation maps generated with the third model (pretrained with PICL) closely match the ground truth annotations, with relatively few variations across different protocols, even though it was only trained with data from protocol 1. In contrast, the first and second models often failed to capture fine details and exhibited significant boundary discrepancies, particularly when dealing with protocol variations that were not seen during training.

The third model (pretrained with PICL) achieved a mean coefficient across all protocol variations, substantially outperforming the other two models, which achieved a mean Dice coefficient of 0.82 (train from scratch) and 0.94 (pretrain without PICL). This improvement demonstrates the effectiveness of the disclosed techniques in generating invariant features that enhance segmentation accuracy across different acquisition protocols.

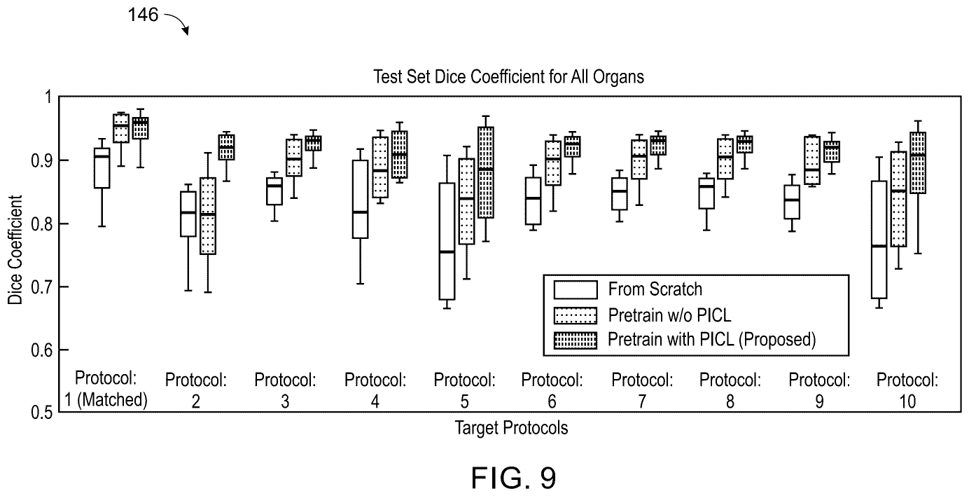

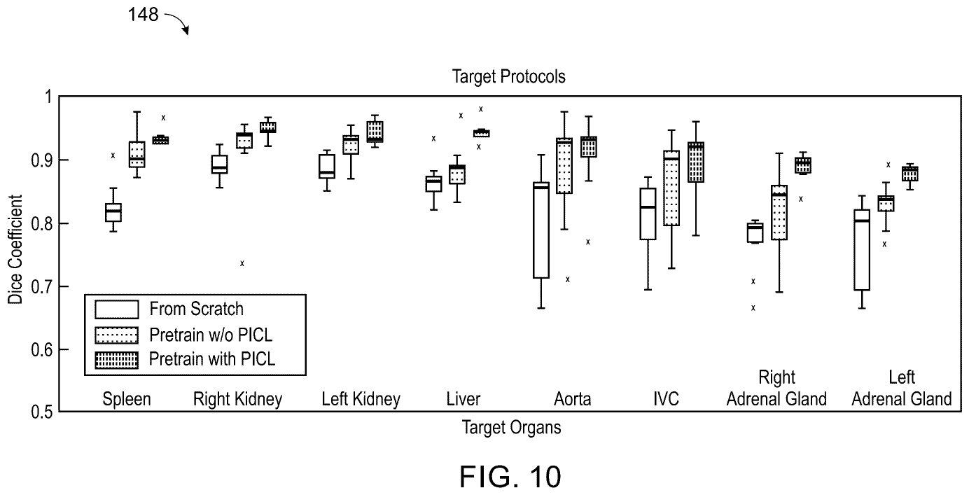

FIG. 9 depicts a graph 146 of the Dice coefficients stratified by protocol for the segmentation performance on various imaging protocols for the first, second, and third models utilized in FIG. 8. FIG. 10 depicts a graph 148 of Dice coefficients stratified by organ for the segmentation performance on various imaging protocols for the first, second, and third models utilized in FIG. 8. In both graphs 146, 148, the Dice coefficients for the third model (pretrained with PICL) are consistently higher than both the first model (trained from scratch) and the second model (pretrained w/o PICL). Also, the third model shows significantly less inter-protocol Dice coefficient variation compared to both the first model (trained from scratch) and the second model (pretrained w/o PICL) with 40 to 50 percent reduction in standard deviation. Compared to the first model (trained from scratch), the third model (pretrained with PICL) improved the Dice coefficient from 0.89 to 0.94 when tested on the training protocol and from 0.82 to 0.91 when tested on unseen protocols. These findings demonstrate that the disclosed techniques enhance the reliability and generalizability of deep learning models in medical imaging such as CT. Although the results in FIGS. 8-10 relate to segmentation, the disclosed techniques may be extended to other downstream tasks such as image denoising and image enhancement.

Technical effects of the disclosed embodiments include providing systems and methods for training a robust medical imaging foundation model and derivative models. Technical effects of the disclosed embodiments include utilizing a label-free self-supervised learning framework for medical imaging that significantly reduces domain shift by employing a PICL function to train a protocol-invariant encoder of a foundation model. Using the PICL, a generalist PIE is trained that can be used for other downstream tasks by training a corresponding decoder and thus generate a derivative model from the foundation model. By ensuring that different images of the same patient (e.g., subject) produce similar feature representations, the disclosed techniques significantly reduce domain shift of the resulted deep learning models across protocol variations.

Technical effects of the disclosed embodiments include utilizing contrastive learning for medical imaging that leverages physics-based models to generate different CT scans of the same patient under varying acquisition protocols. Using contrastive learning, the foundation model is trained to generate similar features for these varied scans aiming to create a robust and protocol-invariant feature representations. By ensuring the different scans of the same patient produce consistent feature representations, the disclosed techniques significantly reduce the discrepancies that typically arise when a model trained on one protocol is applied to another. The foundation model generated with the disclosed techniques serves as a base model for developing robust and protocol-invariant downstream deep learning models (e.g., for denoising and segmentation). Technical effects of the disclosed embodiments include reducing the amount of training data need while increasing the robustness of the resulting downstream deep learning models.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform] ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

This written description uses examples to disclose the present subject matter, including the best mode, and also to enable any person skilled in the art to practice the subject matter, including making and using any devices or systems and performing any incorporated methods. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A computer-implemented method for generating a medical imaging foundation model and a medical imaging derivative model, comprising:
randomly selecting, via processing system comprising one or more processors, both a subset of subjects from a plurality of subjects and one or more medical images from different protocols for each respective subject of the subset of subjects;
obtaining, via the processing system, an encoder-decoder framework; and
pretraining, via the processing system, an encoder of the encoder-decoder framework with the one or more medical images from different protocols for each respective subject of the subset of subjects utilizing self-supervised learning with a physics informed contrastive loss function to generate a trained protocol invariant encoder configured to be utilized for different downstream tasks, wherein utilizing the physics informed contrastive loss function promotes similar latent space features to be extracted from the one or more medical images of a same subject from different protocols while repelling latent space features from different subjects, and wherein the similar latent space features represent a same underlying anatomical structure.

2. The computer-implemented method of claim 1, further comprising freezing, via the processing system, weights of the trained protocol invariant encoder to generate the medical imaging derivative model.

3. The computer-implemented method of claim 2, further comprising training, via the processing system, a decoder of the encoder-decoder framework for a particular downstream task with medical images from a single protocol of different subjects while the weights of the trained protocol invariant encoder remain frozen.

4. The computer-implemented method of claim 3, wherein, after training the decoder, the encoder-decoder framework is configured to be utilized on medical images from different protocols for the particular downstream task.

5. The computer-implemented method of claim 4, wherein, after training the decoder, the encoder-decoder framework is configured to be resistant to domain shift.

6. The computer-implemented method of claim 1, wherein, when pretraining the encoder of the encoder-decoder framework with the one or more medical images from different protocols, the encoder of the encoder-decoder framework is pretrained to extract features via auto-encoding and inpainting with random masks.

7. The computer-implemented method of claim 6, wherein the encoder of the encoder-decoder framework is pretrained with the one or more medical images from different protocols utilizing both the physics informed contrastive loss function and self-supervised L1 loss function from the auto-encoding and the inpainting.

8. The computer-implemented method of claim 1, wherein the encoder-decoder framework comprises a vision transformer for the encoder.

9. The computer-implemented method of claim 1, wherein at least some medical images of the one or more medical images from different protocols for the plurality of subjects are simulated medical images generated from actual reference medical imaging data of at least some subjects of the plurality of subjects.

10. The computer-implemented method of claim 9, wherein selection of medical images for the subset of subjects is from computed tomography (CT) images.

11. The computer-implemented method of claim 10, wherein the simulated medical images are generated by:
obtaining, via the processing system, actual reference medical imaging data acquired with a CT scan of a respective subject;
generating, via the processing system, a multi-material voxelized phantom based on the actual reference medical imaging data; and
utilizing, via the processing system, physics-based models to systematically vary acquisition parameters to generate CT imaging data of the respective subject from a series of CT scans representing different protocols from the actual reference medical imaging data.

12. A system for generating a medical imaging foundation model and a medical imaging derivative model, comprising:
a memory encoding processor-executable routines; and
a processing system comprising one or more processors and configured to access the memory and to execute the processor-executable routines, wherein the processor-executable routines, when executed by the processing system, cause the processing system to:
randomly select both a subset of subjects from a plurality of subjects and a one or more medical images from different protocols for each respective subject of the subset of subjects;
obtain an encoder-decoder framework; and
pretrain an encoder of the encoder-decoder framework with the one or more medical images from different protocols for each respective subject of the subset of subjects utilizing self-supervised learning with a physics informed contrastive loss function to generate a trained protocol invariant encoder configured to be utilized for different downstream tasks, wherein utilizing the physics informed contrastive loss function promotes similar latent space features to be extracted from the one or more medical images of a same subject from different protocols while repelling latent space features from different subjects, and wherein the similar latent space features represent a same underlying anatomical structure.

13. The system of claim 12, wherein the processor-executable routines, when executed by the processing system, further cause the processing system to freeze weights of the trained protocol invariant encoder to generate the medical imaging derivative model.

14. The system of claim 13, wherein the processor-executable routines, when executed by the processing system, further cause the processing system to train a decoder of the encoder-decoder framework for a particular downstream task with medical images from a single protocol of different subjects while the weights of the trained protocol invariant encoder remain frozen, and wherein, after training the decoder, the encoder-decoder framework is configured to be utilized on medical images from different protocols for the particular downstream task and the encoder-decoder framework is configured to be resistant to domain shift.

15. The system of claim 12, wherein at least some medical images of the one or more medical images from different protocols for the plurality of subjects are simulated medical images generated from actual reference medical imaging data of at least some subjects of the plurality of subjects, and wherein selection of medical images for the subset of subjects is from computed tomography (CT) images.

16. The system of claim 15, wherein the simulated medical images are generated by:
obtaining actual reference medical imaging data acquired with a CT scan of a respective subject;
generating a multi-material voxelized phantom based on the actual reference medical imaging data; and
utilizing physics-based models to systematically vary acquisition parameters to generate CT imaging data of the respective subject from a series of CT scans representing different protocols from the actual reference medical imaging data.

17. A non-transitory computer-readable medium, the non-transitory computer-readable medium comprising processor-executable code that when executed by a processing system comprising one or more processors, causes the processing system to:
randomly select both a subset of subjects from a plurality of subjects and one or more medical images from different protocols for each respective subject of the subset of subjects;
obtain an encoder-decoder framework;
pretrain an encoder of the encoder-decoder framework with the pair of medical images from different protocols for each respective subject of the subset of subjects utilizing self-supervised learning with a physics informed contrastive loss function to generate a trained protocol invariant encoder configured to be utilized for different downstream tasks, wherein utilizing the physics informed contrastive loss function promotes similar latent space features to be extracted from the one or more medical images of a same subject from different protocols while repelling latent space features from different subjects, and wherein the similar latent space features represent a same underlying anatomical structure; and
use the trained protocol invariant encoder to generate a medical imaging derivative model.

18. The non-transitory computer-readable medium of claim 17, wherein the processor-executable code, when executed by the processing system, further causes the processing system to train a decoder of the encoder-decoder framework for a particular downstream task with medical images from a single protocol of different subjects while the weights of the trained protocol invariant encoder remain frozen, and wherein, after training the decoder, the encoder-decoder framework is configured to be utilized on medical images from different protocols for the particular downstream task and the encoder-decoder framework is configured to be resistant to domain shift.

19. The non-transitory computer-readable medium of claim 17, wherein at least some medical images of the one or more medical images from different protocols for the plurality of subjects are simulated medical images generated from actual reference medical imaging data of at least some subjects of the plurality of subjects, and wherein selection of medical images for the subset of subjects is from computed tomography (CT) images.

20. The non-transitory computer-readable medium of claim 19, wherein the simulated medical images are generated by:
obtaining actual reference medical imaging data acquired with a CT scan of a respective subject;
generating a multi-material voxelized phantom based on the actual reference medical imaging data; and
utilizing physics-based models to systematically vary acquisition parameters to generate CT imaging data of the respective subject from a series of CT scans representing different protocols from the actual reference medical imaging data.
